(19) United States
(12) Patent Application Publication
(10) Pub. No.: US 2025/0130048 A1
(43) Pub. Date: Apr. 24, 2025

(54) Incremental Neural Network Model Inference

(71) Applicant: Advanced Space, LLC, Westminster, CO (US)

(72) Inventors: Nathan Parrish Ré, Billings, MT (US); Timothy M. Sullivan, Colorado Springs, CO (US); Kirk S. Roerig, Loveland, CO (US); Matthew D. Popplewell, Westminster, CO (US); Tyler M. Hanf, Broomfield, CO (US)

(21) Appl. No.: 18/925,394

(22) Filed: Oct. 24, 2024

Related U.S. Application Data
(60) Provisional application No. 63/592,787, filed on Oct. 24, 2023.
(60) Provisional application No. 63/594,182, filed on Oct. 30, 2023.

(51) Int. Cl. G01C 21/24; G06N 3/082

(52) U.S. Cl. CPC G01C 21/24; G06N 3/082

(57) ABSTRACT

An incremental neural network model inference method for updating a navigation state estimate of a spacecraft includes: reading parameters and functions from a current layer of a neural network model into a memory of a spacecraft computer, performing a transformation on a navigation state estimate with the parameters and functions, saving a transformed navigation state estimate to the memory, and determining whether the current layer of the neural network model is the last layer. When the current layer is not the last layer, the method includes: removing the parameters and functions from the memory; incrementing to a next layer of the neural network model; repeating the steps of reading, transforming, and removing for the next layer of the neural network model until all layers are transformed; when the current layer is the last layer, the method includes: outputting a thrust command.

### CROSS-REFERENCE TO RELATED APPLICATIONS

This application claims the benefit of priority of U.S. Provisional Patent Application No. 63/592,787, entitled Incremental Neural Network Model Inference, and filed on Oct. 24, 2023; and, U.S. Provisional Patent Application No. 63/594,182, entitled Almanac of Neural Network Models, and filed on Oct. 30, 2023, the disclosures of which are herein incorporated by reference in their entirety.

### BACKGROUND

### 1. Field

Embodiments of the invention relate generally to the field of space navigation systems, and more specifically to systems employing neural networks for optimizing navigation controls in space.

### 2. Related Art

Space navigation systems are an integral part of both manned and unmanned space flights since the inauguration of space missions in the 1960s. Space navigation requires complicated calculations, taking into account not only the speed, the location, and the inertia of the spacecraft, but also the gravity field and many interspace perturbations from nearby planets and objects.

Multiple methods have been provided for spacecraft navigation using neural networks.

For example, United States Patent Application Publication No. 2022/0227503 to Barnhart et al. discloses a system using genetic algorithms for safe swarm trajectory optimization. United States Patent Application Publication No. 2002/0083027 to Biggers et al. discloses a neural network trajectory command controller for controlling trajectory of an object. U.S. Pat. No. 8,880,246 to Karpenko et al. discloses method and apparatus for determining spacecraft maneuvers using a control law or steering law as a path constraint or as a dynamic constraint. Foreign reference CN112114521 to Xu et al. discloses an intelligent prediction control entry guidance method for a spacecraft. Foreign reference CN111498148 to Deng et al. discloses an FDNN-based intelligent spacecraft control method. Foreign reference RU2304549C2 discloses a self-contained onboard control system of “gasad-2a” spacecraft. Foreign reference CN112580819 discloses to Huyan et al. a low-orbit satellite precise orbit determination strategy supported by machine learning. Foreign reference CN114111773 to Liu et al. discloses a combined navigation method, a device, a system and a storage medium. Foreign reference KR102314038 discloses a method of determining a singular area, a method of generating an onboard map, and a method of determining a direction of a lander. Non-patent literature to Garcia et al. discloses an electric propulsion intelligent control (EPIC) toolbox for proximity operations and safety analysis in low-earth orbit (LEO). Non-patent literature to LaFarge et al. discloses a hybrid closed-loop guidance strategy for low-thrust spacecraft enabled by neural networks. Non-patent literature to Mughal et al. discloses a design of deep neural networks for transfer time prediction of spacecraft electric orbit-raising. Non-patent literature to Rubinstein et al. discloses a neural network optimal control in astrodynamics for application to the missed thrust problem.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, an incremental neural network model inference method for updating a navigation state estimate of a vehicle includes: providing a neural network model to a computer onboard the vehicle, wherein the computer is configured to execute the neural network model onboard the vehicle; reading parameters and functions from a layer of the neural network model into a memory of the computer; transforming a navigation state estimate with the parameters and functions via the computer and saving a transformed navigation state estimate to the memory; removing the parameters and functions from the memory; incrementing to a next layer of the neural network model; repeating the steps of reading, transforming, and removing for the next layer of the neural network model until all layers are transformed; and outputting a navigation command.

In another embodiment, an incremental neural network model inference method for updating a vehicle state vector includes: providing a neural network model having a plurality of layers to a vehicle computer, wherein the vehicle computer is configured to execute the neural network model onboard the vehicle; reading parameters and functions from a current layer of the neural network model into a memory of the vehicle computer; performing a linear transformation on a navigation state estimate with the parameters and functions via the vehicle computer and saving a transformed navigation state estimate to the memory; determining whether the current layer of the neural network model is the last layer; when the current layer is not the last layer: performing a nonlinear transformation on the transformed navigation state estimate; removing the parameters and functions from the memory; incrementing to a next layer of the neural network model; and, repeating the steps of reading parameters and functions for a next layer of the neural network model, performing a linear transformation, and determining whether the current layer is the last layer; and when the current layer is the last layer: outputting a force command.

In yet another embodiment, an incremental neural network model inference method providing reduced memory requirements includes: inputting parameters and functions from an initial layer of a neural network model into a memory of a computer, wherein the neural network model comprises a plurality of layers; transforming a sequence of vectors with the parameters and functions via the computer and saving a transformed sequence of vectors to the memory; removing the parameters and functions from the memory; incrementing to a next layer of the neural network model; repeating the steps of reading, transforming, and removing for the next layer of the neural network model until all layers are transformed; and, outputting a neural network model output, wherein the neural network model output provides a prediction based on the parameters and functions.

### BRIEF DESCRIPTION OF THE DRAWING FIGURES

Embodiments of the invention are described in detail below with reference to the attached drawing figures, wherein:

FIG. 1A is a schematic diagram showing a prior art ground-based control architecture for spacecraft navigation;

FIG. 1B is a schematic diagram showing an autonomous neural network control architecture for spacecraft navigation that takes place onboard the spacecraft;

FIG. 2 is a schematic diagram showing steps of an autonomous neural network control method for spacecraft navigation; and

FIG. 3 is a flow diagram of an incremental neural network model inference method, in an embodiment.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Space navigation requires accurately determining a spacecraft's trajectory periodically. Early trajectory determination techniques relied on optical tracking with telescopes. A single observation consists of two angular measurements (right ascension and declination). Therefore, a minimum of three measurements at three different epochs is required to provide six independent quantities required for a trajectory determination. Examples of optical tracking techniques include the method of Laplace, the method of Gauss, and the double r-iteration method.

Modern trajectory determination technologies depend on ground stations to pinpoint the position and movement of spacecraft. The ground stations use mechanisms such as radar, signal doppler, and laser reflectors to acquire orbital mechanics to calculate where the spacecraft is at a specific point in time. The orbital mechanics information is then compiled into an ephemeris table to calculate a precise position of the spacecraft. Other known remote sensing techniques can assist in space navigation by providing information in combination with the Global Navigation Satellite System (GNSS).

Spacecrafts are generally equipped with propulsion systems capable of providing small amounts of thrust for making orbital maneuvers. High thrust systems may operate for short bursts (seconds to minutes), while low thrust systems may operate over longer timeframes (days to weeks). For low thrust systems, small amounts of thrust may be applied over a significant fraction of a mission trajectory, which causes the optimal control problem (OCP) of shifting the spacecraft trajectory to be continuous rather than discrete, typically making the design of trajectories computationally more demanding.

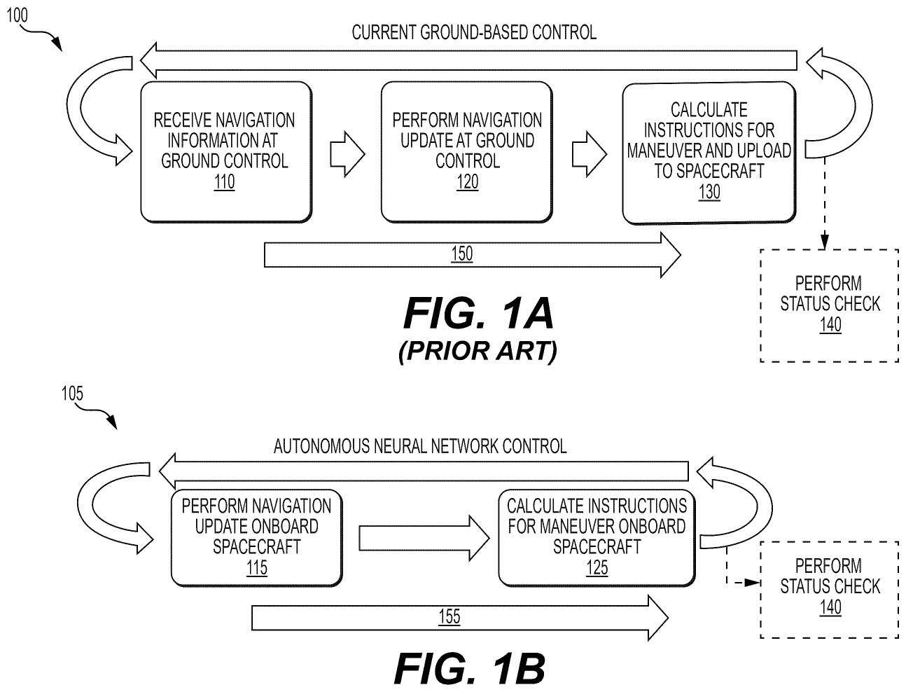

As illustrated in a schematic diagram of FIG. 1A, space missions are currently operated via a ground-based mission control center (MCC) using a ground-based control method 100. The MCC manages spaceflight operations from launch until landing or the end of the mission. A staff of flight controllers and other support personnel monitor all aspects of the mission using telemetry and sending commands to the spacecraft using ground stations. Personnel supporting the mission from an MCC can include representatives of the attitude control system, power, propulsion, thermal, attitude dynamics, orbital operations and other subsystem disciplines.

In a step 110, navigation information for the spacecraft is received at the MCC. In an example of step 110, the MCC receives navigation information about the spacecraft and determines a state (e.g., a position vector and a velocity vector) of the spacecraft.

In a step 120, a navigation update is performed at the MCC. In an example of step 120, the MCC predicts a next state of the spacecraft. For example, a position vector and velocity vector of the spacecraft is predicted for the next contact time with the spacecraft.

In a step 130, instructions for a maneuver are calculated and uploaded to the spacecraft. In an example of step 130, the MCC uploads commands from the ground control station to the spacecraft. The instructions may be for the spacecraft to coast or for the thrusters to execute a maneuver, for example.

In an optional step 140, a status check is performed. In an example of step 140, the ground team may perform periodic status checks on the spacecraft state.

Method 100 occurs over a timeframe 150. Timeframe 150 may be on the order of days to weeks due to the time lag for communicating with a distant spacecraft from the ground control station. The uncertainty of the spacecraft state increases with increasing timeframes.

Method 100 is then repeated by returning to step 110.

Long-distance communication between the ground-based MCCs and spacecraft far from Earth requires large and sensitive scientific telecommunications systems. For example, NASA's Deep Space Network (DSN) consists of three facilities spaced equidistant from each other—approximately 120 degrees apart in longitude—around the world. These sites are at Goldstone, near Barstow, California; near Madrid, Spain; and near Canberra, Australia. The strategic placement of these sites permits constant communication with spacecraft as our planet rotates—before a distant spacecraft sinks below the horizon at one DSN site, another site picks up the signal.

Each of the three DSN sites has multiple large antennas and is designed to enable continuous radio communication between several spacecraft and Earth. All three complexes consist of at least four antenna stations, each equipped with large parabolic dish antennas and ultra-sensitive receiving systems capable of detecting incredibly faint radio signals from distant spacecraft. For example, one of the massive antennas, located at NASA's Goldstone Deep Space Communications Complex in Barstow, California, is the 70-meter (330-foot) DSS-14 antenna. Each complex is situated in semi-mountainous, bowl-shaped terrains to shield against external radio frequency interference. For maintaining an effective long-distance communication, the DSN's large antennas have focusing mechanisms that concentrate power when receiving data and when transmitting commands. The antennas must point very accurately towards the spacecraft in a tiny portion of the sky. To hear the spacecraft's faint signal, the antennas must be equipped with amplifiers. However, there are two challenges. First, the signal becomes degraded by background radio noise, or static, emitted naturally by nearly all objects in the universe, including the sun and earth. The background noise gets amplified along with the signal. Second, the powerful electronic equipment amplifying the signal adds noise of its own. The DSN uses highly sophisticated technology, including cooling the amplifiers to a few degrees above absolute zero, and special techniques to encode signals so the receiving system can distinguish the signal from the unwanted noise. Antenna stations are remotely operated from a signal processing center at each complex. The centers house electronic systems that point and control the antennas, receive and process data, transmit commands and generate spacecraft navigation data.

The antennas of the Deep Space Network are the indispensable link to explorers venturing beyond Earth. Space mission operations teams use the DSN Command System to control the activities of their spacecraft. Commands are sent to robotic probes as coded computer files that the craft execute as a series of actions. The DSN Tracking System provides two-way communication between Earth-based equipment and a spacecraft, making measurements that allow flight controllers to determine the position and velocity of spacecraft with great precision. They provide the crucial connection for commanding our spacecraft and receiving their never-before-seen images and scientific information on Earth, propelling our understanding of the universe, our solar system and ultimately, our place within it. In addition to its vital role as the communications hub for deep space exploration, the DSN is also used as an advanced instrument for scientific research, including radio astronomy and radar mapping of passing asteroids.

As missions voyage further from Earth, it is important to continuously communicate with these spacecrafts and navigate them through space when they are so far from these ground-based control stations. In recent years, advanced spacecrafts have been designed and built to reach further away locations such as the Sun, Mercury, Mars, Jupiter and the Didymos asteroids—a trend that will continue into the years ahead. As such, a new challenge appears in view of this trend.

FIG. 1B illustrates an exemplary autonomous neural network control method 105 for autonomously controlling navigation of a spacecraft. In contrast to using ground-based control, which operates with outdated navigation data, the onboard autonomous control uses the latest navigation data in real-time or near real-time. Compared with ground-based control, onboard autonomous control may provide an immediate course correction. A neural network (NN) model approximates solutions to the optimal control problem with minimal computational overhead, operating as a feedback controller. The NN model is trained with a set of training data. For example, a “training tube” may be established around a nominal path for low-thrust trajectory corrections. In embodiments, the training tube refers to position and velocity errors around the nominal path. The NN model is then trained to respond to the position and velocity errors within the training tube and return the position and velocity values back to the nominal path values within a predetermined time frame Δt. In some embodiments, checkpoints are employed prior to especially sensitive parts of a trajectory (e.g., a flyby or other critical maneuver) to help ensure that the NN model can maintain the spacecraft path within the training tube. In certain embodiments, several NN models are trained, with each NN model being responsible for a section of a nominal transfer, which may produce better results compared to training one NN model over the entire transfer. Outputs of the one or more NN models may be compared to traditional methods (e.g., Monte Carlo simulations) to evaluate performance of the one or more NN models.

In a step 115, an onboard navigation update is performed. In an example of step 115, a computer onboard the spacecraft determines a state of the spacecraft (e.g., position, direction, and velocity of the spacecraft) and calculates navigation updates of the spacecraft state to predict a next state of the spacecraft (e.g., at a target epoch). In embodiments, the spacecraft may receive information for determining the state of the spacecraft from the Global Positioning System (GPS), the optical navigation system, or the Cislunar Autonomous Positioning System (CAPS), for example. In some embodiments, the onboard computer determines the spacecraft state based on an earlier navigation update. Alternatively, the spacecraft state may also be determined based on information from instruments onboard the spacecraft.

In a step 125, instructions for a maneuver are calculated onboard the spacecraft. In an example of step 125, a navigation state estimate is input to a NN model via an onboard computer, and maneuver instructions are output from the NN model.

In optional step 140, a status check is performed. In an example of step 140, the spacecraft onboard computer performs periodic status checks. The status check outcomes may be transmitted to a ground control station for monitoring.

Method 105 occurs over a timeframe 155. Timeframe 155 is on the order of minutes (e.g., ten minutes) due to the neural network calculations being performed locally on the spacecraft flight computer. Therefore, the spacecraft state remains accurate due to the short timeframe. The short timeframe also enables the spacecraft to make immediate course corrections whenever necessary. For a long duration maneuver (days to weeks), instructions for the next maneuver may be updated repeatedly on a shorter timeframe (e.g., every 5 to 10 minutes) while the maneuver is happening by using the NN model onboard the spacecraft.

Following step 125, method 105 is repeated by returning to step 115. Method 105 may be repeated at a more frequent rate compared with method 100 due to timeframe 155 being much shorter compared to timeframe 150.

Neural networks (NN), also known as artificial neural networks (ANNs) or simulated neural networks (SNNs), are a subset of machine learning algorithms. Their name and structure are inspired by the human brain, mimicking the way that biological neurons signal to one another. Artificial neural networks (ANNs) are comprised of a node of layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural network (NN) control provides a means for on-board maneuver correction without over-simplifying the calculations by learning the relationship between a spacecraft's state and an optimal maneuver to maintain an operational slot. The spacecraft's guidance and navigation system may evaluate the NN control in-flight, resulting in a reduction in operational costs and improvement in maneuver accuracy.

A neural network control for electric propulsion (NNEP) algorithm may be used with the following non-limiting examples: (1) application of NNEP algorithm to maneuver corrections for minimum-fuel transfers; (2): application of NNEP algorithm to GEO station keeping; (3) application of NNEP algorithm to Earth-Moon Halo Orbit station keeping; (4) application of NNEP algorithm to trajectory correction maneuvers for a chemical propulsion interplanetary mission; (5) application of NNEP algorithm to many-revolution spiral transfers; and (6) LEO station keeping. In embodiments, neural networks may also be used for missions with chemical propulsion, for large or small maneuvers, and for a range of dynamical environments including Earth orbit, the cislunar environment, and interplanetary space.

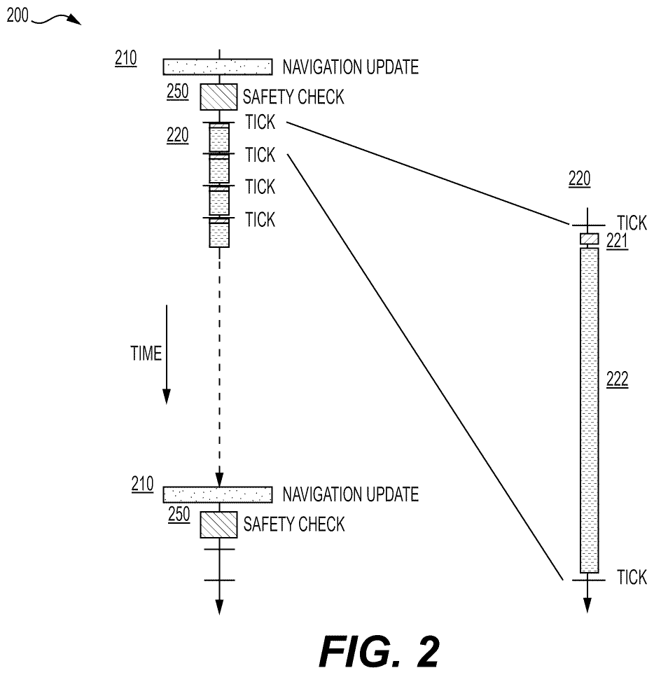

A method 200 is illustrated in FIG. 2 as a schematic diagram showing the steps of an exemplary concept of operations (ConOps) method for Optimal Low Thrust Artificial Intelligence Reoptimization (OLTAIR). The ConOps method of OLTAIR may be modified to suit particular mission constraints. Method 200 is an example of autonomous neural network control method 105 of FIG. 1B used for low-thrust maneuver correction. The ConOps method of OLTAIR comprises software, logically broken-up into two distinct sections: (1) Liboltair, which contains the platform-independent core autonomous trajectory correction logic; and (2) The cFS ecosystem, which contains all platform-specific functionality to use Liboltair in a flight-safe environment. Liboltair further includes a set of user-defined platform-specific interfaces, a generated ‘almanac’ containing a set of time dependent pre-trained neural network models, and the core logic to operate on the almanac and to utilize the interfaces as needed for autonomous trajectory corrections. Liboltair may operate through a single-entry point function known as the ‘tick’ function to avoid a control-loop specific design.

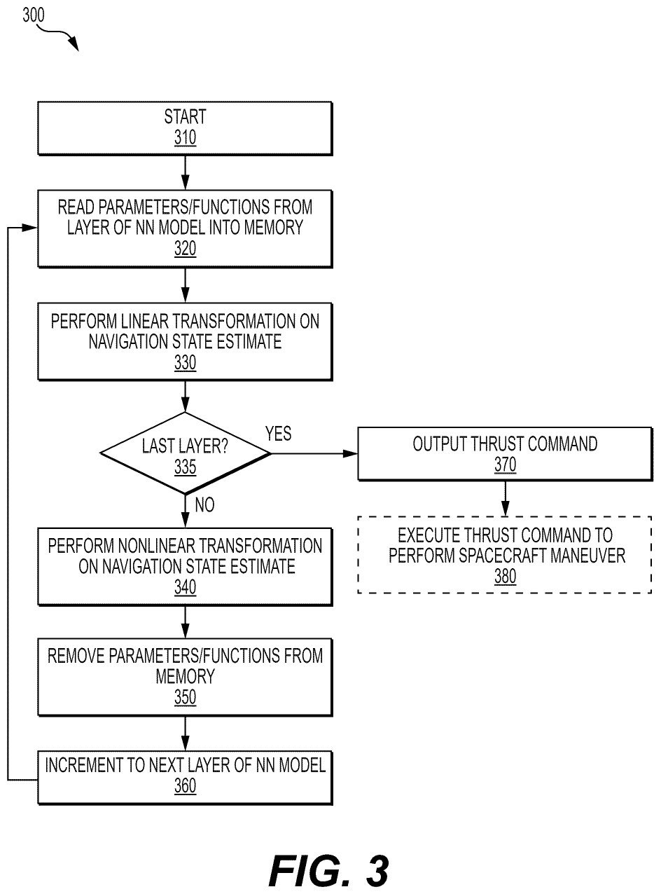

A navigation update 210 comprises a spacecraft computer receiving a navigation update and determines a current spacecraft state (e.g., state x^{→}(t)), as described below in connection with FIG. 3. Navigation update 210 may be provided live by the Global Positioning System (GPS), the optical navigation system, or the Cislunar Autonomous Positioning System (CAPS). Alternatively, navigation update 210 may be a logical calculation based on an earlier live navigation update, or navigation update 210 may be acquired by instruments onboard the spacecraft.

Following navigation update 210, an exemplary neural network safety check method 250 may be performed. For example, an onboard computer may perform the neural network safety check method 250 to evaluate one or more ticks 220, prior to the spacecraft executing any tick function, as further described below in connection with FIG. 3. For example, method 250 may propagate NN model outputs immediately after they are generated and evaluate whether an expected final state is within a predetermined tolerance. If an evaluation by the neural network safety check method 250 passes, then method 200 executes the one or more ticks 220. An exemplary neural network safety check method is described in U.S. Pat. No. 18,664,743, filed May 15, 2024, and entitled Neural Network Safety Check, which is herein incorporated by reference in its entirety.

Each tick 220 includes two separate maneuver types: a computer maneuver design 221 and a spacecraft maneuver 222. In embodiments, the computer maneuver design 221 performs the autonomous trajectory correction logic of Liboltair described above. The computer maneuver design 221 includes the following steps: 1) The computer checks the current state and estimates if a maneuver is needed in this step. If the maneuver is not needed in this step, the computer coasts to the next tick evaluation. If the maneuver is needed in this step, the computer performs the next computer maneuver step. 2) The computer identifies the relevant model weights to read from an almanac. The almanac is a collection structure of neural networks, which contains NN models and ancillary information. 3) The computer evaluates NN models to map a state estimate x^{→}(tᵢ) to a maneuver Δv^{→}(tᵢ). 4) The onboard propagator predicts a next state x^{→}(tᵢ₊₁), assuming the spacecraft executes the commanded maneuver perfectly. 5) The computer increments to the next tick 220. It takes less than a second for the computer to perform the individual steps of the computer maneuver design 221. Executing the spacecraft maneuver 222 may take minutes or longer. Because the computer maneuver design 221 is performed much more quickly than the spacecraft maneuver 222, the neural network safety check method 250 is able to execute a series of steps of the computer maneuver design 221 without performing the spacecraft maneuver 222 and evaluate the spacecraft commands and outcomes much faster than, and prior to, the real-time execution of the spacecraft maneuver 222. Following a successful evaluation by the NN safety check method 250, the spacecraft maneuver 222 may then be executed. Once the spacecraft executes a commanded thrust, it then coasts until the next tick 220. One or more ticks 220 may be performed until the spacecraft computer receives a next set of navigation updates 210. The spacecraft computer then repeats the NN safety check method 250 and one or more ticks 220 in another cycle.

A working example of a neural network model is the application of neural network control for electric propulsion (NNEP) in 3-Body orbits. The reliability of the NN model has been tested at the following three levels: 1) the NN is automatically demonstrated with every code version submitted to a version control system, which verifies that the NN output vector matches expected values when provided with a given set of weight parameters and a given input vector; and, 2) the NN is tested via Monte Carlo trials on ground computers, which includes randomly sampling an expected distribution of spacecraft states for which the NN should be valid, evaluating the NN on each of those states, and propagating the output to the target epoch. Monte Carlo ground testing verifies that the NN training did not overfit the training data and that the NN is accurate for flight operations. If the NN is found to be inaccurate, a smaller NN model may be used, which provides more robust but less precise outputs, and/or more training samples may be generated for the NN model. The testing provides information as to how a spacecraft responds to stressing situations prior to uploading the NN to the spacecraft. (3) The NNEP technology has reliability built into its architecture. For example, the flight software (FSW) propagates the NN outputs immediately after they are generated, evaluating whether the expected final state is within tolerance and whether path constraints (e.g., eclipses or close approaches to other bodies) are met.

Historically, achieving a 2-day navigation and control update loop with human-in-the-loop control has required 24-hr coverage from operations teams and is only practical for short periods of critical operations. In contrast, once a state estimate is available for NNEP, thruster commands may be provided immediately, drastically reducing the time of the navigation and control update loop, while also automating the process. When the thruster is throttled smoothly, the NN model output is virtually indistinguishable from a perfect, ground-generated solution.

In embodiments, the onboard spacecraft computer calculates neural network (NN) outputs from the NN model. The NN outputs may be from any NN model, including but not limited to a NN electric propulsion (NNEP) algorithm applied for use with various spacecraft maneuvers such as those described above. In one particular example regarding maneuver corrections for minimum-fuel transfers, the onboard neural network control for electric propulsion (NNEP) model is used to calculate and return the minimum-energy solution: minimizing ∫u(t)²dt, where u(t) is the control magnitude at time t. While that provides accurate solutions, real spacecraft operations are typically more concerned with the minimum-fuel solution: minimizing ∫u(t)dt. The minimum-fuel solution has discontinuities at thrust on/off switching points making it a much more difficult and sensitive optimization problem. The minimum-fuel solution is also discontinuous in the relationship between state x^{→}(t) and costate λ^{→}(t) at time t, making it hard for a NN model to accurately learn the control response to a given state error. To get around the discontinuity problem, NN models are trained on the smoothed-minimum-fuel problem. For the smoothed-minimum-fuel problem, the objective is modified to: ∫(u+∈[u log u+(1−u) log (1−u)])dt, where u=u(t) and ∈ is a smoothing term. When ∈ is small (˜10⁻⁴), the optimal solution is nearly indistinguishable from the true minimum-fuel solution. When ∈ is large (˜0.1), the optimal solution resembles the minimum-energy solution. In embodiments, using ∈=10⁻² works well by providing nearly-fuel-optimal solutions while also being smooth enough for NN models to accurately capture the relationship between state x^{→}(t) and costate λ^{→}(t). For the onboard NNEP model, one or a plurality of NN inputs, including the current time (t*), the perturbed position δr^{→}, and the perturbed velocity δv^{→}, are calculated and propagated to target epochs. The fixed-time two-point boundary value problem (TPBVP) is solved for the transfer back to the nominal at time t*+Δt, where the time interval Δt is fixed and may be on the order of a few days or tens of days.

Following calculation of the NN model outputs, the NN model output is propagated to the next target epoch (i.e., the next “tick”) to determine a next navigation state of the spacecraft. In an example of maneuver corrections for minimum-fuel transfers, the onboard computer propagates the spacecraft state with NN model output control to the next tick epoch.

Prior to use of a NN model onboard a spacecraft, extensive Monte Carlo random sampling may be performed on the ground. Expected error sources such as orbit determination inaccuracies, thruster mis-calibration or off-pointing, and temporary forced-coasting periods are randomly sampled in end-to-end simulations of the trajectory or orbit where the NN model will be used.

In some embodiments, a time-ordered almanac having multiple time-based neural network models may be used to determine course corrections over the duration of a transfer or maneuver. The almanac contains ancillary information that, together with the structure of the almanac, maps each neural network model to its corresponding epoch range and stores parameters used when simulating NNEP control. In some embodiments, each neural network model in the time-ordered almanac is a multilayer perceptron (MLP), also known as a fully-connected feed-forward model. Each neural network model is responsible for only a section of the nominal transfer operation. Experience has suggested this produces better results than attempting to train one neural network over an entire transfer/maneuver, especially for long duration transfers/maneuvers.

FIG. 3 is a flow diagram of an incremental neural network model inference method 300. In embodiments, method 300 uses incremental (i.e., one layer at a time) neural network inference for each NN model. Method 300 may be performed by an onboard spacecraft computer running the OLTAIR software described above, for example. However, method 300 may be performed by a computer onboard any vehicle such as a terrestrial vehicle or aircraft for providing a navigation command without departing from the scope hereof. Additionally, method 300 may be performed by a computer for predicting any desired outputs based on a given set of input parameters and functions from an appropriately trained model. For example, method 300 may be used with a natural language prediction neural network model.

In a step 310, method 300 starts. In an example of step 310, method 300 starts prior to initiation of a spacecraft maneuver or transfer. In embodiments using a time-ordered almanac of NN models, method 300 starts with the first time-ordered NN model in the almanac which includes a navigation state estimate x^{→}(tᵢ) of the spacecraft.

In step 320, method 300 reads input data (e.g., a binary file) into memory. In an example of step 320, the onboard spacecraft computer reads parameters (e.g., weights and biases) and/or functions from disk for a first layer of a first time-ordered NN model and loads the parameters/functions into memory (e.g., RAM) of the onboard spacecraft computer. The parameters/functions may comprise network parameters, weights, or biases and/or other information associated with the NN model. The parameters/functions are previously obtained by training the NN model on a large set of possible trajectories of the spacecraft transfer or maneuver. The NN model is prefixed by a model header which indicates how many NN layers are found in the model, and NN layers are stored immediately after the model header. Each NN layer begins with a layer header which is then followed by the appropriate number of parameters (e.g., weights and/or biases) stored as doubles. In some embodiments, a parameter matrix is stored in memory of the onboard computer as a weight matrix which is augmented with a vector of biases.

In a step 330, a linear transformation is performed on the navigation state estimate x^{→}(tᵢ) using the parameters in memory to provide a transformed navigation state estimate \vec{y}(tᵢ). In an example of step 330, the onboard spacecraft computer performs one or more linear transformations on the navigation state estimate with the parameters (e.g., the weights and/or biases).

In a step 335, a decision is made as to whether the current NN model layer is the last layer. If the current layer is the last layer, method 300 proceeds to step 370. If the current layer is not the last layer, method 300 proceeds to step 340.

In a step 340, a nonlinear transformation is performed on the transformed navigation state estimate \vec{y}(tᵢ) using a function on each component of the vector. For example, each component may be transformed independently using a simple function determined previously while training the NN model.

In a step 350, the parameters/functions are removed from memory. In an example of step 350, the onboard spacecraft computer removes the parameters and functions from memory for the current layer of the NN model. However, the transformed navigation state estimate \vec{y}(tᵢ) remains in memory.

In a step 360, method 300 increments to the next layer of the NN model and returns to step 320 to repeat the process for the next layer. When method 300 returns to step 320, the parameters for the next NN model layer are read into memory, and in step 330 the next linear transformation is performed on the transformed navigation state estimate from step 350 of the previous layer.

As steps 320, 330, 340, and 350 are repeated for subsequent layers of the NN model, method 300 progresses through multiple layers of the NN model and the navigation state estimate \vec{y}(tᵢ) is progressively transformed. For example, for a NN model having five layers, parameters/functions of the first layer are loaded into memory in step 320 and transformed in steps 330 and 340, then the first layer parameters/functions are removed from memory in step 350 and the method increments to the second layer of the NN model in step 360. Steps 320, 330, and 340 are then repeated to transform the navigation state estimate \vec{y}(tᵢ) from the first transformation using the second layer parameters/functions, and so on for all five layers of the NN model. For the last layer, however, method 300 proceeds to step 370 following decision step 335. In other words, the output from the last NN model layer follows the linear transformation step 330.

In step 370, a thrust command is output from the NN model. In an example of step 370, an inference is made for a current target epoch and the transformed navigation state estimate \vec{y}(tᵢ) is provided to a spacecraft host process as a thrust command. A downstream process may then determine what to do with the thrust command.

In an optional step 380, the thrust command is executed by the onboard spacecraft computer to perform a maneuver based on the updated navigation state estimate. The maneuver may be used to perform a minimum-fuel transfer, for example, or the maneuver may be a correction maneuver performed by a thrust, a pair of thrusts, or a series of thrusts to maintain a trajectory. Alternatively, the maneuver may be a coast in which no thrust is provided. Step 380 is optional because in some instances, the transformed navigation state estimate \vec{y}(tᵢ) from the NN model may be sufficiently similar to the previous navigation state estimate x^{→}(tᵢ) indicating that a maneuver is not needed (e.g., the resulting thrust command is zero or negligibly small). As such, no thrust command is executed and the spacecraft coasts until the next tick epoch.

Typically, NN model calculations are performed with an entire NN model being loaded into memory at once. Instead, method 300 performs the transformation calculations one layer at a time from a NN model have multiple layers. Method 300 produces the following favorable characteristics: 1) each NN model is statically allocated, and the parameters are read from disk and evaluated one layer at a time, which reduces memory requirements; 2) the flight software (FSW) is simplified such that there is no need to reload the parameters if newer models become available: and, 3) the documentation of the cFS application implementation of OLTAIR software is provided in an accompanying file during uplink to the spacecraft, further simplifying the FSW.

Artificial intelligence applications are typically solved using substantial computing power which is not feasible for a spacecraft computer. By performing method 300, real-time calculations may be performed with a lightweight spacecraft computer enabling autonomous spacecraft navigation using NN modeling. For example, a binary file containing data from each layer of the NN model may be read and processed on low-level hardware (e.g., edge computing using a GPU, FPGA, microprocessor, etc.) with only 100s of KB of overhead. In contrast, a large NN model typically has GBs of parameters to load into memory. Many flight computers are limited to only about 1 GB of RAM due to spacecraft constraints (e.g., size, weight, electrical power), space radiation hardening requirements, and prior spacecraft mission success.

Additionally, method 300 may be performed for other types of neural network models to provide predictive outputs based on a given set of input parameters and functions from an appropriately trained model. For example, method 300 may be used with a natural language prediction neural network model.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An incremental neural network model inference method for updating a navigation state estimate of a vehicle, the method comprising:
providing a neural network model to a disk storage of a computer onboard the vehicle, wherein the computer is configured to execute the neural network model onboard the vehicle;
reading parameters and functions from a layer of the neural network model into a memory of the computer;
transforming a navigation state estimate with the parameters and functions via the computer and saving a transformed navigation state estimate to the memory;
removing the parameters and functions from the memory;
incrementing to a next layer of the neural network model;
repeating the steps of reading, transforming, and removing for the next layer of the neural network model until all layers are transformed; and
outputting a navigation command.

2. The method of claim 1 comprising executing the navigation command for a current target epoch.

3. The method of claim 1, wherein the step of transforming the navigation state estimate comprises performing a linear transformation on the navigation state estimate.

4. The method of claim 3 comprising determining whether the layer of the neural network model currently in memory is the last layer following the step of performing the linear transformation.

5. The method of claim 4, wherein upon determining that the layer of the neural network model layer is the last layer, proceeding to the step of outputting the navigation command based on the transformed navigation state estimate.

6. The method of claim 4, wherein upon determining that the layer of the neural network model layer is not the last layer, performing a nonlinear transformation on the transformed navigation state estimate.

7. The method of claim 1, wherein the parameters and functions are previously obtained by training the neural network model on a set of possible trajectories for a maneuver of the vehicle.

8. The method of claim 1, wherein the parameters and functions comprise one or more of network parameters, weights, biases or other information associated with the neural network model.

9. The method of claim 1, wherein the navigation state estimate is progressively transformed upon repeating steps for the next layer of the neural network model.

10. The method of claim 1, wherein the step of transforming the navigation state estimate with the parameters and functions is performed for one layer of the neural network model at a time, wherein the neural network model comprises a plurality of layers.

11. An incremental neural network model inference method for updating a vehicle state vector, the method comprising:
providing a neural network model having a plurality of layers to a vehicle computer, wherein the vehicle computer is configured to execute the neural network model onboard the vehicle;
reading parameters and functions from a current layer of the neural network model into a memory of the vehicle computer;
performing a linear transformation on a navigation state estimate with the parameters and functions via the vehicle computer and saving a transformed navigation state estimate to the memory;
determining whether the current layer of the neural network model is the last layer;
when the current layer is not the last layer:
performing a nonlinear transformation on the transformed navigation state estimate;
removing the parameters and functions from the memory;
incrementing to a next layer of the neural network model; and
repeating the steps of reading parameters and functions for a next layer of the neural network model, performing a linear transformation, and determining whether the current layer is the last layer; and
when the current layer is the last layer:
outputting a force command.

12. The method of claim 11 comprising executing the force command for a current target epoch.

13. The method of claim 11, wherein the parameters and functions are previously obtained by training the neural network model on a set of possible trajectories for a maneuver of the vehicle.

14. The method of claim 11, wherein the navigation state estimate is progressively transformed upon repeating steps for the next layer of the neural network model.

15. The method of claim 11, wherein the step of performing a linear transformation on the navigation state estimate with the parameters and functions is performed for one layer of the neural network model at a time.

16. An incremental neural network model inference method providing reduced memory requirements, the method comprising:
inputting parameters and functions from an initial layer of a neural network model into a memory of a computer, wherein the neural network model comprises a plurality of layers;
transforming a sequence of vectors with the parameters and functions via the computer and saving a transformed sequence of vectors to the memory;
removing the parameters and functions from the memory;
incrementing to a next layer of the neural network model;
repeating the steps of reading, transforming, and removing for the next layer of the neural network model until all layers are transformed; and
outputting a neural network model output, wherein the neural network model output provides a prediction based on the parameters and functions.

17. The method of claim 16, wherein the step of transforming the sequence of vectors comprises performing a linear transformation on the sequence of vectors.

18. The method of claim 17, comprising performing a nonlinear transformation on the transformed sequence of vectors.

19. The method of claim 16, wherein the sequence of vectors is progressively transformed upon repeating steps for the next layer of the neural network model.

20. The method of claim 16, wherein the sequence of vectors comprises a sequence of embedded word tokens.
